(19) United States
(12) Patent Application Publication
(10) Pub. No.: US 2026/0052460 A1
(43) Pub. Date: Feb. 19, 2026

(54) NTN SELECTION BASED ON CONNECTION DURATIONS

(71) Applicant: T-Mobile USA, Inc., Bellevue, WA (US)

(72) Inventors: Kun Lu, Bellevue, WA (US); Ryan David Colter, Bellevue, WA (US); Egil Gronstad, Encinitas, CA (US); Jun Liu, Issaquah, WA (US); Brian Allan Olsen, Bellevue, WA (US)

(21) Appl. No.: 18/805,088

(22) Filed: Aug. 14, 2024

(51) Int. Cl. H04W 48/20; H04W 84/06

(52) U.S. Cl. CPC H04W 48/20; H04W 84/06

(57) ABSTRACT

Described herein is a user equipment (UE) configured to determine a plurality of connection durations available at the location of the UE from a respective plurality of satellites of a non-terrestrial network (NTN) and to select a satellite from the plurality of satellites based on the available connection durations.

### BACKGROUND

User equipment (UEs) often are configured to select access networks of terrestrial networks based on their respective signal strengths. The signal strengths are measured by the UEs and may be evaluated with other criteria (radio access technologies of the access networks, etc.). The UEs then select and camp on access networks based on the results of these evaluations.

With non-terrestrial networks (NTNs), the satellites acting as the base stations of the NTNs may all be orbiting the Earth at significant distances from the UEs, leading to smaller differences between their respective signal strengths. Such smaller differences may lead to greater difficulty for a UE in selecting among multiple satellites. Further, satellites may each be moving in different directions and available for different periods of time, and handovers between satellites may have additional complexities.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram of a UE travelling among cells served by multiple satellites of NTNs for varying connection durations.

FIG. 2 is a flow diagram of an illustrative process implemented by a UE for determining a plurality of connection durations available at the location of the UE from a respective plurality of satellites of an NTN and selecting a satellite from the plurality of satellites based on the available connection durations.

FIG. 3 is a schematic diagram of a computing device capable of implementing functionality of at least one of a UE, a satellite, or a telecommunications network device described herein.

### DETAILED DESCRIPTION

This disclosure is directed in part to a user equipment (UE) configured to determine a plurality of connection durations available at the location of the UE from a respective plurality of satellites of a non-terrestrial network (NTN) and to select a satellite from the plurality of satellites based on the available connection durations. The UE may be travelling through cells of a telecommunications network served by the satellites and may, as part of satellites assistance information broadcast by the satellites, determine the connection duration for each satellite. Such connection durations may specify an amount of time that a given satellites will continue to serve a specific cell. Receiving the connection durations from the satellites, the UE may select the satellite offering the longest connection duration.

In some implementations, satellites may not provide connection durations. With such satellites, information such as their latitudes and longitudes, elevations, and trajectories may be obtained at some frequency (e.g., daily) and use to estimate locations of the satellites and connect durations offered by cells intersecting with those locations. The UE may obtain this information and select a satellite with a longest connection duration base on it.

In some examples, satellites providing satellite assistance information may be examples of Third Generation Partnership Project (3GPP) satellites and those not providing the satellite assistance information may be examples of non-3GPP satellites. The UE can receive signals from both and either select the satellite among both 3GPP and non-3GPP satellites with the longest connection duration or preferentially select from one group (e.g., the 3GPP satellites) and only select from the other group (e.g., non-3GPP satellites) if satellites from the preferred group are unavailable.

In various implementations, the UE may also filter out satellites from those detected based on signal strength that is more than a threshold below the signal strengths provided by the other satellites or based on map/terrain information. Such map/terrain information could suggest that a satellite may not offer continuous connectivity despite an advertised connection duration because of a geographic feature (e.g., mountain or building) that impairs the signal received by the UE.

Also, besides simply considering the location of the UE and which cell that location is in, the UE can consider its projected travel plans (e.g., driving to a meeting at a specific location) and whether any of the satellites is more likely to offer a better connection duration across multiple adjacent cells of the travel plans. If such a satellite is detected, the UE may select that satellite.

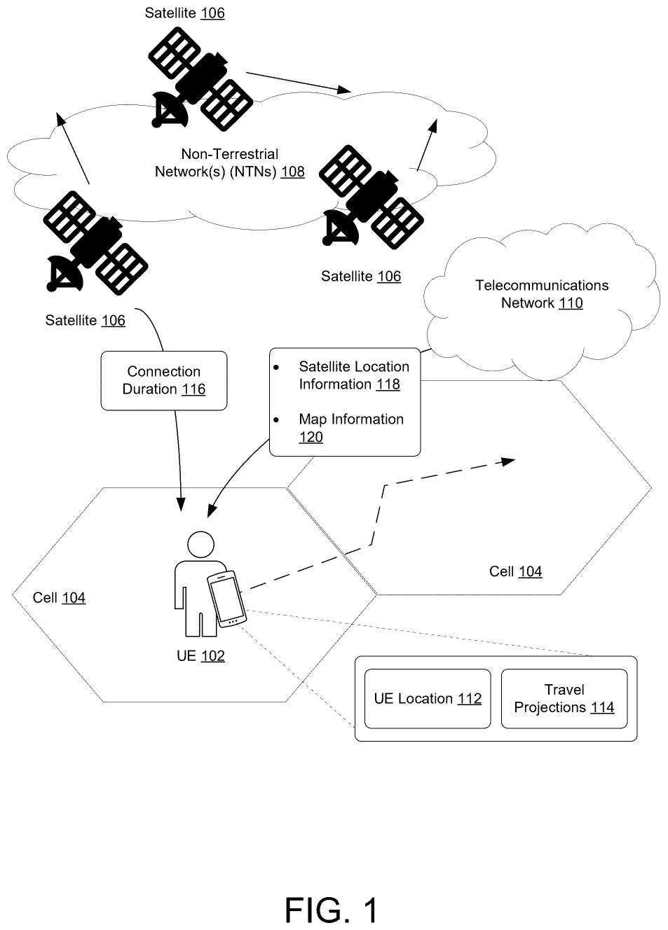

FIG. 1 is an overview diagram of a UE travelling among cells served by multiple satellites of NTNs for varying connection durations. As illustrated, a UE 102 located within a cell 104 may have coverage available from a plurality of satellites 106 of one or more NTNs 108. The satellites 106 may provide connectivity to a telecommunications network 110 within the cell 104, each for some period of time as flies over the cell 104. The UE 102 may be configured to determine its location 112 and, in some examples, its travel projections 114 across multiple cells 104. With this information and connection durations 116 provided by satellites 106, the UE 102 selects a satellite 106 to support its connection. For satellites 106 that do not provide connection durations 116, the UE 102 may receive and utilize satellite location information 118 obtained through the telecommunications network 110. Lastly, the UE 102 may have or obtain map information 120 and use the map information 120 to filter the satellites 106 it considers.

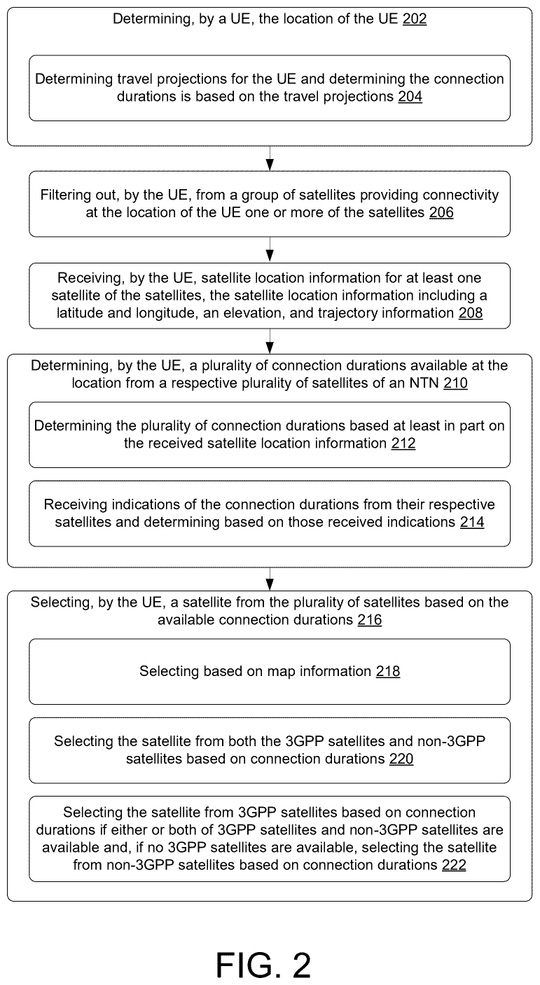

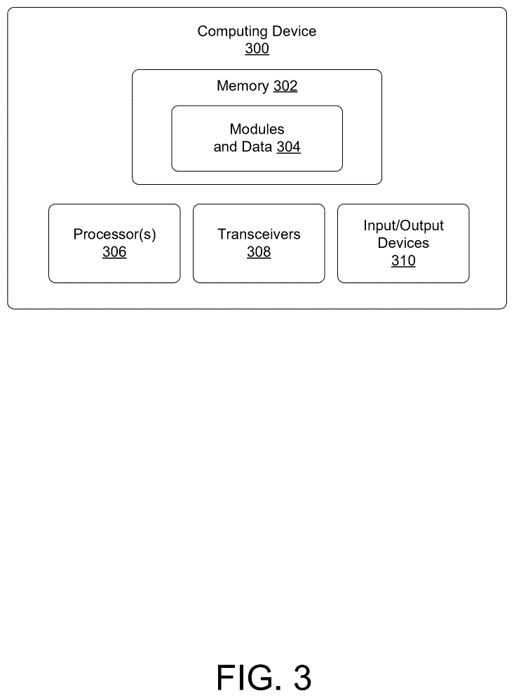

In various implementations, the UE 102 may be any sort of device capable of sending and receiving wireless communications with one or more satellites 106. In some examples, the UE 102 may also be capable of wireless communication with terrestrial access points, such as radio access network (RAN) base stations or wireless routers. UE 102 may be a cellular phone, a tablet computer, a watch, goggles, an Internet-of-Things (IoT) device, a personal computer (PC), a gaming device, or any sort of mobile telecommunications device. The UE 102 is also described in greater detail herein with respect to FIGS. 2 and 3.

The UE 102 may move through telecommunications network cells, such as cells 104. Like cells of a terrestrial network that may be fixed to specific locations defined by physical placement of the base stations supporting them, the cells 104 may also be statically defined locations (e.g., by coordinates such as latitudes and longitudes) that may serve as reference for where a satellite 106 provides coverage and how long it provides the coverage for. The operator of the telecommunications network 110 may provide the bounds of these cells 104 to the UE 102, satellites 106, or both for use in determining current cells/locations and for determining connection durations. While both the UE 102 and the satellites 106 may move, the geocoordinate boundaries of the cells 104 may remain the same.

In various implementations, the satellites 106 may form any one or more NTNs 108 and may orbit the Earth, sending and receiving wireless communications with terrestrial objects such as UE 102. Satellites 106 may each have an orbit/trajectory, a speed, tilt(s) of one or more antennas, and configuration enabling the satellites 106 to adjust any of the orbit/trajectory, speed, tilt(s), as well as other aspects such as transmission power of its antenna(s) or positioning of its power source solar panels. Satellites 106 may include either or both of 3GPP or non-3GPP satellites. 3GPP satellites may be configured to broadcast satellite assistance information specified by the 3GPP, including parameters such as connection duration 116. Satellites 106 may also communicate with each other for handovers of connections for a UE 102 between satellites 106. In some examples, the satellites 106 may also communicate with terrestrial base stations and routers to handover connections with them, and/or with nodes of a core network of the telecommunications network 110 (either directly or through base stations/routers or gateway devices). In some examples, the satellites 106 may also receive, from time to time, definitions of cells 104 to be used in determining connection durations 116.

The telecommunications network 110 may include access networks and a core network of a network operator. The core network may be a Fifth Generation (5G), Fourth Generation (4G), Third Generation (3G), or other later or earlier generation core network. The core network may include one or more nodes implementing network functions, such as those for charging, session management, authentication, etc., as well as storage of information such as subscriber profiles. In some implementations, the core network may generate, store, and/or provide satellite location information 118, map/terrain information 120, or both. The access networks may include terrestrial base stations, non-terrestrial base stations (e.g., satellites 106) or both and may also implement 6G, 5G, 4G, 3G, or earlier or later generation radio access technology. The access networks may have wireless connections to the UE 102 and other devices and may be connected to the core network by wired backhaul, wireless backhaul, or a combination of both.

In various implementations, as the UE 102 moves through cells 104, the UE 102 may determine its location 112. The UE 102 may determine its location 112 using global positioning system (GPS) technology, global navigation satellite system (GNSS), triangulation using adjacent devices (e.g., terrain-based base stations, etc.) or other mechanism(s). The UE 102 may do this on a periodic basis or in response to event(s), such as seeking to identify a satellite 106 to provide the UE 102 with connectivity.

In some implementations, the UE 102 may also determine travel projections 114 and locations along those travel projections. The travel projections 114 may be provided by a platform of the UE 102, by an application of the UE 102, or by the telecommunications network 110 or another service. Such travel projections 114 may be learned from behavior of the user of the UE 102 (e.g., travelling into work at a certain time each day) and updated as user experience develops.

The UE 102 may also receive broadcasts from satellites 106 advertising connection durations 116. Such connection durations 116 may be specified in in satellite assistance information generated by the satellites 106 and provided to devices in range of their broadcasts, including UE 102. A connection duration 116 for a satellite 106 may also be determined by a satellite 106 based on its position. For example, a satellite 106 may be aware of its geocoordinates and the corresponding area of geocoordinate on Earth where it can provide coverage. The satellite 106 may also be aware of its trajectory, speed, and that of the Earth. Based on all of these, the satellite 106 can calculate a remaining coverage time for one or more cells 104 that correspond to geocoordinates on Earth where it can provide coverage. These coverage times-referred to herein as connection durations 116-may then be broadcast by the satellites 106 as part of 3GPP defined satellite assistance information. For instance, the connection durations 116 may be specified in t-service parameters of satellite assistance information in the NR-NTN SIB19 message.

In further implementations, the UE 102 may receive broadcast signals from satellites 106 or detect satellites 106 upon performing a radio frequency (RF) scan but may not receive connection durations 116 from some or all of these satellites 106. In an example, if a satellite 106 is identified by a unique identifier or by other information that can served to uniquely identify the satellite 106, the UE 102 may determine satellite location information 118 for that satellite 106. Such satellite location information 118 can be based on a larger set of satellite location information 118 that has satellite identifiers, latitudes and longitudes, elevations, and trajectory information for those corresponding satellites 106. The larger set can be obtained from a third-party provider of satellite locations (e.g., North American Aerospace Defense Command (“NORAD”)) by the telecommunications network 110 or directly by the UE 102 and processed to calculate connection durations 116 at cells 104 for each listed satellite 106 over a time period (e.g., 24 hours). In some implementations, only connection durations 116 for a subset of satellites 106 are calculated by filtering out satellites that are unlikely to pass through cells 104. If processed by the telecommunications network 110, the UE 102 may receive connection durations 116 for specific satellites 106 or for all satellites 106 providing coverage at a specific cell 104 during a specific time range.

In some implementations, the UE 102 may also calculate connection durations 116 for satellites 106 available in cells 104 passed through based on travel projections 114, allowing aggregation of connection durations 116 across cells 104.

In various implementations, after determining its location 112 and/or travel projections 114 and receiving connection durations 116 or calculating connection durations 116 based on satellite location information 118, the UE 102 may select the satellite 106 providing the longest connection duration 116 for the cell 104. In some implementations, connection durations 116 for a satellite 106 may be aggregated across adjacent cells 104 when travel projections 114 indicate that a UE 102 may pass through both in succession. In such circumstances, aggregated connection durations 116 are considered by the UE 102 in selecting the satellite 106 with the longest connection duration 116.

In further implementations, the UE 102 can select among both 3GPP satellites 106 (satellites 106 providing 3GPP specified satellite assistance information) and non-3GPP satellites 106, either without preference based on type, or may preferentially select among one type (e.g., 3GPP satellites 106) based on length of connection duration 116 and then select among the other type if no satellite 106 of the preferred type is available. In other implementations, the UE 102 may only select from one of 3GPP satellites 106 or non-3GPP satellites based on its configuration.

In some implementations, the UE 102 may also filter out one or more satellites 106 from consideration before selecting among the resulting satellites 106. For example, the UE 102 could measure the signal strength of each detected satellite 106 and if the signal strength of one of the detected satellites 106 is more than a threshold amount below the average or median or next lowest signal strength, the UE 102 may exclude that satellite 106 from consideration in selecting a satellite 106 for connection. In another example, the UE 102 may consider map/terrain information 120 received from the telecommunications network 110 in determining which satellites 106 to consider. If the UE 102 is located in a cell 104 that includes a geographic feature (e.g., building, mountain, etc.) that could significantly affect connectivity and result in a handover, the UE 102 may exclude one or more of the satellites 106 before considering the connection durations 116 offered by the remainder.

As the UE 102 leaves a cell 104 and enters into another cell 104, it may repeat the operations described herein with respect to FIGS. 1 and 2, which may lead to selection of a new satellite 106 for coverage. Alternatively, the UE 102 can wait until the connection drops or its quality fades to a certain level before repeating the operations described herein.

FIG. 2 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 2 is a flow diagram of an illustrative process implemented by a UE for determining a plurality of connection durations available at the location of the UE from a respective plurality of satellites of an NTN and selecting a satellite from the plurality of satellites based on the available connection durations. As illustrated at 202, a UE determines its location (i.e., a location of the UE). At 204, in some implementations, the determining may comprise determining travel projections for the UE and determining the connection durations is based on the travel projections.

At 206, the UE may filter out from a group of satellites providing connectivity at the location of the UE one or more of the satellites. The UE may filter out the one or more of the satellites based on, e.g., having a signal strength below a threshold (or more than a threshold below the other satellites). Also or alternatively, the UE may filter out the one or more of the satellites based on map information.

At 208, the UE may receive satellite location information for at least one satellite of the plurality of satellites, the satellite location information including a latitude and longitude of the at least one satellite, an elevation of the at least one satellite, and trajectory information of the at least one satellite.

At 210, the UE determines a plurality of connection durations available at the location from a respective plurality of satellites of an NTN. At 212, in some implementations, the determining may comprise determining the plurality of connection durations based at least in part on the received satellite location information. At 214, the determining may also or instead comprise receiving indications of the connection durations from their respective satellites and determining based on those received indications. The connection durations available at the location may be determined at each satellite and may specify a time at which each satellite will stop providing service at the location of the UE.

At 216, the UE selects a satellite from the plurality of satellites based on the available connection durations. At 218, in some implementations, the selecting may be based on map information. At 220, the selecting may include selecting the satellite from both the 3GPP satellites and non-3GPP satellites based on connection durations. At 222, the selecting may include selecting the satellite from 3GPP satellites based on connection durations if either or both of 3GPP satellites and non-3GPP satellites are available and, if no 3GPP satellites are available, selecting the satellite from non-3GPP satellites based on connection durations.

FIG. 3 is a schematic diagram of a computing device capable of implementing functionality of at least one of a UE, a satellite, or a telecommunications network device described herein. As shown, the computing device 300 includes a memory 302 storing modules and data 304, processor(s) 306, transceivers 308, and input/output devices 310.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 302 can include one or more software or firmware elements, such as computer-readable instructions that are executable by the one or more processors 306. For example, the memory 302 can store computer-executable instructions associated with modules and data 304. The modules and data 304 can include a platform, operating system, and applications, and data utilized by the platform, operating system, and applications. Further, the modules and data 304 can implement any of the functionality for the UE 102, a satellite 106, a device of the telecommunications network 110, or any other node/device described and illustrated herein.

In various examples, the processor(s) 306 can be a central processing unit (CPU), a graphics processing unit (GPU), or both CPU and GPU, or any other type of processing unit. Each of the one or more processor(s) 306 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 306 may also be responsible for executing all computer applications stored in the memory 302, which can be associated with types of volatile (RAM) and/or nonvolatile (ROM) memory.

The transceivers 308 can include modems, interfaces, antennas, Ethernet ports, cable interface components, and/or other components that perform or assist in exchanging wireless communications, wired communications, or both.

While the computing device need not include input/output devices 310, in some implementations it may include one, some, or all of these. For example, the input/output devices 310 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 310 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 310 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as 5G/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and NTN communications. Thus, the scope of the disclosure is not limited to the examples described herein.

What is claimed is:

1. A method comprising:
determining, by a user equipment (UE), a location of the UE;
determining, by the UE, a plurality of connection durations available at the location from a respective plurality of satellites of a non-terrestrial network (NTN); and
selecting, by the UE, a satellite from the plurality of satellites based on the available connection durations.

2. The method of claim 1, wherein determining the plurality of connection durations comprises receiving indications of the connection durations from their respective satellites.

3. The method of claim 2, wherein the connection durations available at the location are determined at each satellite and specify a time at which each satellite will stop providing service at the location of the UE.

4. The method of claim 1, further comprising receiving satellite location information for at least one satellite of the plurality of satellites, the satellite location information including a latitude and longitude of the at least one satellite, an elevation of the at least one satellite, and trajectory information of the at least one satellite.

5. The method of claim 4, wherein determining the plurality of connection durations is based at least in part on the received satellite location information.

6. The method of claim 1, wherein the plurality of satellites includes one or both of Third Generation Partnership Project (3GPP) satellites and non-3GPP satellites.

7. The method of claim 6, wherein the plurality of satellites includes both of 3GPP satellites and non-3GPP satellites and the selecting comprises selecting the satellite from both the 3GPP satellites and non-3GPP satellites based on connection durations.

8. The method of claim 6, wherein the selecting comprises selecting the satellite from the 3GPP satellites based on connection durations if either or both of the 3GPP satellites and the non-3GPP satellites are available and, if no 3GPP satellites are available, selecting the satellite from the non-3GPP satellites based on connection durations.

9. The method of claim 1, further comprising utilizing map information to perform at least one of filtering out one or more of the satellites or the selecting the satellite, wherein the selecting is based on both the connection durations and the map information.

10. The method of claim 1, further comprising filtering out one or more of the satellites if the one or more of the satellites has a signal strength below a threshold.

11. The method of claim 1, wherein determining the location of the UE comprises determining travel projections for the UE and determining the connection durations is based on the travel projections.

12. A system comprising:
one or more processors; and
a user equipment (UE) including at least one of the one or more processors and, when executing the at least one of the one or more processors, performing operations including:
determining a location of the UE;
determining a plurality of connection durations available at the location from a respective plurality of satellites of a non-terrestrial network (NTN); and
selecting a satellite from the plurality of satellites based on the available connection durations.

13. The system of claim 12, wherein the operations further include receiving indications of the connection durations from their respective satellites.

14. The system of claim 13, wherein the connection durations available at the location are determined at each satellite and specify a time at which each satellite will stop providing service at the location of the UE.

15. The system of claim 12, wherein the operations further include receiving satellite location information for at least one satellite of the plurality of satellites, the satellite location information including a latitude and longitude of the at least one satellite, an elevation of the at least one satellite, and trajectory information of the at least one satellite,
wherein determining the plurality of connection durations is based at least in part on the received satellite location information.

16. The system of claim 12, wherein the operations further include utilizing map information to perform at least one of filtering out one or more of the satellites or the selecting the satellite, wherein the selecting is based on both the connection durations and the map information.

17. The system of claim 12, wherein the operations further include filtering out one or more of the satellites if the one or more of the satellites has a signal strength below a threshold.

18. A non-transitory computer storage medium having stored thereon a plurality of programming instructions that, when executed by a user equipment (UE) of a telecommunications network, cause the UE to perform operations comprising:
determining a location of the UE;
determining a plurality of connection durations available at the location from a respective plurality of satellites of a non-terrestrial network (NTN); and
selecting a satellite from the plurality of satellites based on the available connection durations.

19. The non-transitory computer storage medium of claim 18, wherein the operations further comprise receiving indications of the connection durations from their respective satellites,
wherein the connection durations available at the location are determined at each satellite and specify a time at which each satellite will stop providing service at the location of the UE.

20. The non-transitory computer storage medium of claim 18, wherein the operations further comprise receiving satellite location information for at least one satellite of the plurality of satellites, the satellite location information including a latitude and longitude of the at least one satellite, an elevation of the at least one satellite, and trajectory information of the at least one satellite,
wherein determining the plurality of connection durations is based at least in part on the received satellite location information.
